(19) United States
(12) Patent Application Publication
(10) Pub. No.: US 2023/0100007 A1
(43) Pub. Date: Mar. 30, 2023

(54) SYSTEM FOR MONITORING PLUNGER MOVEMENT IN NON-ENERGIZED CONDITION IN REAL TIME

(71) Applicant: PADMINI VNA MECHATRONICS PVT. LTD., GURGAON (IN)

(72) Inventors: KABIR BHANDARI, GURGAON (IN); AMARDIP KUMAR, GURGAON (IN); KUMAR ABHISHEK, GURGAON (IN); SUDHIR PATTNAIK, GURGAON (IN)

(21) Appl. No.: 17/904,150

(22) PCT Filed: Feb. 12, 2021
(86) PCT No.: PCT/IB2021/051186

§ 371 Date: Aug. 12, 2022

(30) Foreign Application Priority Data
Feb. 12, 2020 (IN) 202011006168

(51) Int. Cl. G01D 5/14

(52) U.S. Cl. CPC G01D 5/145; F16K 37/0033

(57) ABSTRACT

The present invention relates to a system for monitoring plunger movement in non-energized condition in real time. More particularly, the present invention relates to a system comprising a plunger, a locking pin, a permanent magnet and a multi-point sensor to measure the position of plunger in a non-energized condition and to improve the automatic shut off or start on the pump.

### FIELD OF THE INVENTION

The present invention relates to a system for monitoring plunger movement in non-energized condition in real time. More particularly, the present invention relates to a system comprising a plunger, a locking pin, a permanent magnet and a multi-point sensor to measure the position of plunger in a non-energized condition and to improve the automatic shut off or start on the pump.

### BACKGROUND OF THE INVENTION

A solenoid device is an electromechanical control unit which shuts or allows the fluid flow, when electrically energized or de-energized. It consists of several parts such as but not limited to solenoid coil, bobbin, moving core, core tube, valve body etc. The magnetic coil of the solenoid is arranged radially relative to the axis of the magnet because the flux of the permanent magnet also extends radially relative to the operating axis of the valve plug and through the armature. There are several areas where solenoid valve is useful such as in pneumatic and hydraulic systems to control cylinders or larger industrial valves, automatic irrigation sprinkler systems also use solenoid valves with an automatic controller.

Many solenoid valves of this type do not provide a means for determining the actual condition of the actuator. In other words, when an electric current is provided to the coil of the solenoid to move the plunger toward one position or the other, no means is readily available to determine if the plunger actually responded to the magnetic field. In solenoid valve which are configured to provide a reciprocating capability, wherein an actuation of the solenoid causes the plunger to move into a first and in a second position after the solenoid coil is deactivated, it is particularly important to be able to determine the actual position of the plunger. The means for determining the actual position of the plunger is important because several malfunctions can possibly cause the plunger to be in a position other than that which is intended. For example, the solenoid coil may not actually have been actuated by the anticipated flow of current through its conductor. This could be caused by a broken wire or ad is connection in the electrical circuit of the solenoid. Even if the solenoid operates properly and the plunger moves in the intended direction, a subsequent shock to the apparatus could possibly cause harm to any of the integral part which leads to un-proper functioning of system.

Patent document WO2019211820A1 discloses, the present invention provides a system for determining plunger position in a solenoid valve and method thereof. More specifically, the invention provides a solenoid valve having hall sensor for detection of plunger position, which provides feedback including output voltage (digital or analog) respective to its position. The solenoid valve includes a nozzle, a spring, a sealing rubber, a poppet, a magnetic bracket, a rubber grommet, a housing sub-assembly, a soft seal, a sensor assembly, a fix core, a moving core and/or plunger, coil, a bobbin sub-assembly, a fix core plate, magnet holder, a permanent magnet and plurality of terminals. In state of the art, it discloses a completely different method to detect the plunger position, yet also there is no apparatus or method disclosed to obtain the plunger position in real time.

Therefore, there is a need of a reliable technique to measure the position of plunger in a non-energized condition and to improve the automatic shut off or start on the pump.

### OBJECT OF THE INVENTION

The main object of the present invention is to provide a system for measuring the position of plunger of oil solenoid valve in non-energized condition.

Another object of the present invention is to provide a system for monitoring the plunger position and for improving the regulation of oil solenoid valve to shut off and start on the pump.

Yet another object of the present invention is to provide a system comprising a plunger, a permanent magnet, a locking pin and a multi-point sensor for locating the plunger movement precisely.

Still another object of the present invention is improving the regulation of pump by the plunger movement and permanent magnet movement corresponding to the plunger position and generating a gauss value.

### SUMMARY OF THE INVENTION

The present invention provides a system to locate the plunger movement and to improve the regulation of oil solenoid valve to shut off and on the pump.

In a main embodiment, the present invention provides a system to monitor the plunger position in non-energized condition comprising a locking pin, a plunger comprises a plurality of grooves, a permanent magnet, and a multi-point sensor. The locking pin comprises a groove lock profile, the groove lock profile inserts into the plurality of grooves of the plunger by the way of rotation, thereby locking the plunger. The permanent magnet is attached to the plunger. As the plunger moves then the multi point sensor records the movement of the plunger through the multi point sensor attached to the permanent magnet even in non-energized condition. When the permanent magnet moves with the plunger, the permanent magnet generates a gauss value corresponding to the position of the plunger and the multi-point sensor converts the gauss value to an equivalent voltage. The multi-point sensor senses the initial position of the plunger and senses the position of plunger with a gap of 0.01 mm.

### BRIEF DESCRIPTION OF THE DRAWINGS

The object of the invention may be understood in more details and more particularly description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIGS. 1(a) and 1(b) shows the front view of the oil solenoid valve when plunger is at initial position and detailed view of the plunger in accordance with an embodiment of the present invention.

FIG. 2 shows the front view of the oil solenoid valve when plunger is at final position in accordance with an embodiment of the present invention.

FIG. 3 shows the cross-sectional view of the plunger in accordance with an embodiment of the present invention.

### DETAILED DESCRIPTION OF THE INVENTION

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The present invention provides a multi-point sensor programming of oil solenoid valve to measure the plunger position in non-energized condition.

In a main embodiment, the present invention provides a system to monitor the plunger position in non-energized condition comprising a locking pin 1, a plunger 2 comprises a plurality of grooves 4, a permanent magnet 3, and a multi-point sensor. The locking pin 1 comprises a groove lock profile, the groove lock profile inserts into the plurality of grooves 4 of the plunger 2 by the way of rotation, thereby locking the plunger 2. The permanent magnet 3 is attached to the plunger 2, when the plunger 2 moves, then the multi-point sensor records the movement of the plunger 2 through the multi-point sensor attached to the permanent magnet 3 even in non-energized condition. When the permanent magnet 3 moves with the plunger 2, the permanent magnet 3 generates a gauss value corresponding to the position of the plunger 2 and the multi-point sensor converts the gauss value to an equivalent voltage. The multi-point sensor senses the initial position of the plunger 2 and senses the position of plunger 2 with a gap of 0.01 mm.

The plunger 2 is made up of material such as but not limited to brass. The locking pin 1 is made up of material such as but not limited to steel and has a plurality of grooves 4 at an angle of 180 degrees. The multi-point sensor senses the position of plunger 2 at a gap of 0.01 mm of the locking pin 1. The multi-point sensor includes such as but not limited to hall sensor. When the locking pin 1 inserts into the plurality of grooves 4 of the plunger 2 encodes the plunger travel. The permanent magnet 3 generates a gauss value that gets converted into a voltage through the sensor attached to said permanent magnet 3. The voltage measured indicates the position of the plunger 2 in non-energized condition.

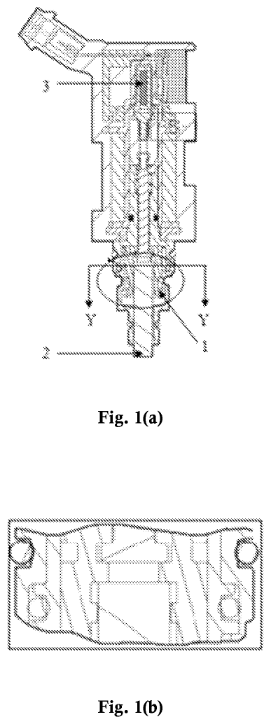

Now referring to FIGS. 1(a) and 1(b), the present invention shows the front view and detailed view of the plunger 2 of oil solenoid valve. The oil solenoid valve comprises of a plunger 2, a permanent magnet 3 and a locking pin 1 and a multi-point sensor (not shown). The plunger 2 is preferably made of brass and has a plurality of grooves (not shown). The locking pin 1 has a groove lock profile that inserts into the plurality of grooves 4 of the plunger 2 by the way of rotation and locks the plunger 2. The permanent magnet 3 is attached to the plunger 2 and when the plunger 2 moves, then the multi-point sensor records the movement of the plunger 2 through the multi-point sensor attached to the permanent magnet 3 even in non-energized condition. The locking pin 1 is preferable made of steel and moves linearly with the plunger 2 to encode the plunger travel.

The permanent magnet 3 along with the multi-point sensor is attached to the plunger 2. When the permanent magnet 3 moves with the plunger 2, the permanent magnet 3 generates a gauss value corresponding to the position of the plunger 2 and the multi-point sensor converts the gauss value to an equivalent voltage. The multi-point sensor senses the position of plunger 2 starting from the initial position of plunger 2 to the gap of 0.01 mm.

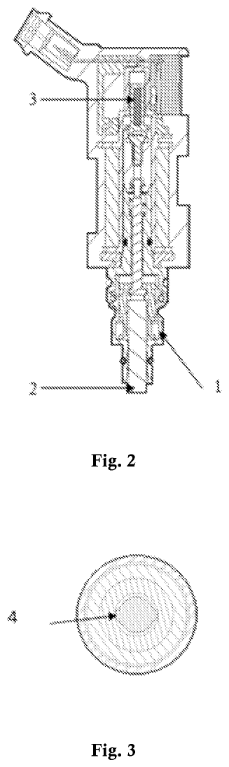

Now referring to FIG. 2, the present invention shows the front view of the oil solenoid valve when plunger is at final position. The plunger 2 movement is measured on the fixture at non-energized condition. The locking pin 1 is also mounted on the fixture and moves linearly to define the plunger travel and encodes the plunger travel through the multi-point sensor.

Now referring to FIG. 3, the present invention shows the cross-sectional view of the plunger 2. The plunger 2 comprises the plurality of grooves 4 at an angle of 180 degrees and the locking pin 1 has a groove lock profile. The locking pin 1 moves into the plurality of grooves 4 of the plunger 2 and locks the plunger 2 by the way of rotation.

Therefore, the present invention provides a system to locate the plunger position in a non-energized position. The system improves the regulation of pump by giving the feedback of plunger position by the means of multi-point sensor. The multi-point sensor attached to the permanent magnet and when the plunger moves the multi-point sensor converts the gauss value of permanent magnet to an equivalent voltage. The system increases the efficiency and life of the oil solenoid valve.

While considerable emphasis has been placed herein on the particular features of this invention, it will be appreciated that various modifications can be made, and that many changes can be made in the preferred embodiments without departing from the principles of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

We claim:

1. A system to monitor plunger position in a non-energized condition comprising:
a locking pin (1);
a plunger (2) comprises a plurality of grooves (4) at a desired angle;
a permanent magnet (3); and
a multi-point sensor;
wherein,
the locking pin (1) comprises a groove lock profile that inserts into the plurality of grooves (4) of the plunger (2) by the way of rotation, thereby locking the plunger (2); and
the permanent magnet (3) is attached to the plunger (2) and when the plunger (2) moves the multi-point sensor records the movement of the plunger (2) through the multi-point sensor attached to the permanent magnet (3) even in non-energized condition.

2. The system as claimed in claim 1, wherein the locking pin (1) is preferably made of steel.

3. The system as claimed in claim 1, wherein the locking pin (1) moves linearly with the plunger (2) to encode the plunger travel.

4. The system as claimed in claim 1, wherein the plunger (2) is preferably made of brass.

5. The system as claimed in claim 1, wherein when the permanent magnet (3) moves with the plunger (2) it generates a gauss value corresponding to the position of the plunger (2) and the multi-point sensor converts the gauss value to an equivalent voltage.

6. The system as claimed in claim 1, wherein the multi-point sensor senses the position of plunger (2) starting from the initial position of the plunger (2) to the gap of 0.01 mm to the locking pin (1).

7. The system as claimed in claim 1, wherein the desired angle of the plurality of grooves (4) on plunger (2) is preferably 180 degrees.

8. The system as claimed in claim 1, wherein the multi-point sensor is preferably a hall sensor.
